(19) United States
(12) Patent Application Publication
(10) Pub. No.: US 2006/0043153 A1
(43) Pub. Date: Mar. 2, 2006

(54) Circuit pattern inspection device and circuit pattern inspection method

(76) Inventors: Shuji Yamaoka, Hiroshima (JP); Hiroshi Hamori, Hiroshima (JP); Shogo Ishioka, Hiroshima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/536,997

(22) PCT Filed: Nov. 28, 2003
(86) PCT No.: PCT/JP03/15290

§ 371 Date: May 31, 2005

(30) Foreign Application Priority Data
Nov. 30, 2002 (JP) 2002-382813

(51) Int. Cl. B23Q 15/00

(52) U.S. Cl. 228/10

(57) ABSTRACT

Disclosed is a circuit pattern inspection apparatus for inspecting a plurality of target patterns 15 arrange in lines at least at first and second opposite ends thereof. The inspection apparatus comprises a supply electrode 35 for supplying an inspection signal and a sensor electrode 25 for detecting a detection signal. Each of the supply and sensor electrodes 35, 25 are adapted to be moved across each of the target patterns with a given gap relative to each of the target patterns 15 in such a manner as to allow the inspection signal supplied from the supply electrode 35 to each of the target patterns 15 through a capacitive coupling, to be detected by the sensor electrode capacitively coupled with each of the target patterns 15, so that the presence of disconnection in the target pattern is determined when the detection signal has a value less than a given lower limit, and the presence of short circuit in the target pattern is determined when the detection signal has a value greater than a given upper limit. According to the inspection apparatus of the present invention, the presence of defect in a circuit board can be inspected reliably and readily.

### TECHNICAL FIELD

The present invention relates to a circuit pattern inspection apparatus and method adapted to inspect the presence of defect in a plurality of conductive patterns formed on a circuit board.

### BACKGROUND ART

A manufacturing process of a circuit board with a plurality of conductive patterns formed thereon unexceptionally include an operation for inspecting whether a disconnection and a short circuit exist in each of and between the conductive patterns.

Heretofore, as a technique for inspecting a plurality of conductive patterns, there has been known a contact (pin contact) method for inspecting a quality parameter, such as conduction, of the conductive patterns, which comprises binging a plurality of pins into contact, respectively, with first and second opposite ends of the conductive patterns, supplying an electrical signal from the pins in contact with the first ends to the conductive patterns, and receiving the electrical signal from the pins in contact with the second ends, as disclosed, for example, in the following Patent Publication 1. In the pin contact method, the electrical signal is supplied by putting a plurality of metal probes serving as the pins, respectively, on all terminals of the conductive patterns, and applying a current from the probes to the conductive patterns.

The pin contact method based on the pin probes in direct contact with the terminals provides an advantage on a high S/N ratio.

Late years, in connection with densification of conductive patterns, the pitch of connecting wirings has become narrower, partly, to less than 50 μm. Accordingly, a probe card is required to have a number of narrower-pitch probes, which drives up a manufacturing cost thereof.

Moreover, the probe card has to be newly prepared for each circuit board different in wiring patterns or on an inspection target-by-inspection target basis. This leads to increase in inspection cost, resulting in hindrance to cost reduction of electronic components.

Further, the probe card with a microstructure is fragile, and thereby has to be used with full attention to avoiding damages thereof during actual inspection.

In that context, a contact-non-contact combinational method has also been proposed that comprises applying an inspection signal including an AC component from a plurality of pin probes in direct contact, respectively, with first ends of a plurality of conductive patterns to be inspected (a pattern to be inspected will hereinafter be referred to occasionally as “target pattern”), and detecting the inspection signal from a probe positioned in non-contact manner with respect to or in spaced-apart relation to second ends of the conductive patterns by a given distance, through a capacitive coupling therebetween, as disclosed, for example, in the following Patent Publication 2.

In the contact-non-contact combinational method, the probe to be positioned relative to the second ends of the conductive patterns has no need to be brought into direct contact with the conductive patterns. Thus, the non-contact probe may be roughly positioned without the need for assuring a high degree of accuracy as in the pin probes. In addition, a single non-contact probe can be shared with the plurality of conductive patterns to reduce the number of probes. Thus, this method can be valid even if the second ends of the conductive patterns are finely spaced.
Patent Publication 1: Japanese Patent Laid-Open Publication No. 62-269075
Patent Publication 2: Japanese Patent Laid-Open Publication No. 11-072524

In the contact-non-contact combinational method, respective probes to be positioned relative to the first and second ends of the conductive patterns, and a processing of the detection signal from the non-contact probe, are specifically designed depending on the intervals between conductive patterns. Thus, the probes and the processing can be used for only one type of circuit board with conductive patterns having a specific configuration or arrangement. Moreover, an associated jig has to be prepared for each circuit board different in conductive patterns.

Further, while the pin probes have to be brought into direct contact, respectively, with the first ends of the conductive patterns, as a prerequisite for the contact-non-contact combinational method, accelerated densification in the first ends makes it difficult to ensure the contact between the pin probes and the first ends. Furthermore, it is intrinsically difficult to avoid the risk of damages in conductive patterns or target patterns, due to the contact with the pin probes.

### DISCLOSURE OF INVENTION

In view of the above conventional problems, it is therefore an object of the present invention to provide an apparatus and method capable of inspecting fine wiring patterns in a simplified structure, and responding to change in wiring patterns.

In order to achieve this object, according to a first aspect of the present invention, there is provided a circuit pattern inspection apparatus for inspecting a plurality of target patterns having first and second opposite ends included in an inspection region thereof and arrange in lines, which is adapted to supply an AC inspection signal from the first end side of the inspection region of the target patterns, and detect a signal from the second end side of the inspection region. The circuit pattern inspection apparatus comprises supply means including a supply electrode for supplying the inspection signal from the first end side of the inspection region of the target patterns, detection means including a sensor electrode for detecting a signal from each of the target patterns, and moving means for moving the supply and sensor electrodes, respectively, across the first and second ends included in the inspection region and arrange in lines, with a given gap relative to each of the target patterns.

In the circuit pattern inspection apparatus set forth in the first aspect of the present invention, each of the target patterns may be a conductive pattern formed on a circuit board to have a bar-like shape with a given width.

In the circuit pattern inspection apparatus set forth in the first aspect of the present invention, the sensor electrode may have a width equal to or greater than a width of two lines of the target patterns.

In the circuit pattern inspection apparatus set forth in the first aspect of the present invention, the sensor electrode may include a first sensor electrode adapted to be disposed at a position opposed to the second end of one of the adjacent target patterns which has the first end supplied with the inspection signal from the supply electrode, and a second sensor electrode adapted to be disposed at a position opposed to the second end of a remaining one of the adjacent target patterns.

The first sensor electrode may have a width equal to or less than each width of the target patterns. The second sensor electrode may have a width equal to or less than each width of the target patterns.

In the circuit pattern inspection apparatus set forth in the first aspect of the present invention, the moving means may be adapted to move the supply and sensor electrodes, respectively, across the first and second ends included in the inspection region and arrange in lines, under the condition that each surface of the supply and sensor electrodes is capacitively coupled with each of the target patterns.

The circuit pattern inspection apparatus set forth in the first aspect of the present invention may further include determination means operable, when a detection result of the detection means based on a detection signal from one of the target patters is in a given acceptable range, to determine that the target pattern is normal, and, when a detection result of the detection means based on a detection signal from one of the target patters is out of the given acceptable range, to determine that the target pattern is defective.

In this case, the circuit pattern inspection apparatus may include second moving means for moving the supply and sensor electrodes to respective positions opposed to the first and second ends of the defective target pattern determined by the determination means, and moving either one of the supply and sensor electrodes along the defective target pattern toward the other electrode, and position detection means for detecting a position where a detection signal from the defective target pattern has a change, in accordance with a detection result of the detection means.

Further, the circuit pattern inspection apparatus may include contacting means for bringing either one of the supply and sensor electrodes into contact with the defective target pattern.

At least one of the supply and sensor electrodes which is to be moved by the second moving means may include an image pickup means.

The above circuit pattern inspection apparatus may include a gap control means for positioning at least one of the supply and sensor electrodes which is to be moved by the second movement means, in such a manner as to allow a gap between the at least one electrode and the defective target pattern to be maintained at an approximately constant value.

The circuit pattern inspection apparatus set forth in the first aspect of the present invention may include a gap control means for positioning at least one of the supply and sensor electrodes to be moved by the movement means, in such a manner as to allow a gap between the at least one electrode and each of the target patterns to be maintained at a constant value.

The gap control means may include a displacement measurement device disposed at a position adjacent to the sensor or supply electrode and adapted to be moved together with the sensor or supply electrode, the gap control means being operable to position the sensor or supply electrode in a direction orthogonal to the inspection region in accordance with a detection result of the displacement measurement device, in such a manner as to allow a gap between the sensor or supply electrode and the inspection region to be maintained at an approximately constant value

Further, the gap control means may be operable to position the sensor or supply electrode in a direction orthogonal to the inspection region, on the basis of a gap between the sensor or supply electrode and the inspection region which is defined by an average displacement of a detection result of the displacement measurement device obtained from a plurality of pitches of the target patterns.

According to a second aspect of the present invention, there is provided a circuit pattern inspection method for use in a circuit pattern inspection apparatus which comprises supply means including a supply electrode for supplying an inspection signal to each of a plurality of target patterns having first and second opposite ends included in an inspection region thereof and arrange in lines, from the first end side of the inspection region, and detection means including a sensor electrode for detecting a signal from each of the target patterns. The circuit pattern inspection method comprises moving the supply and sensor electrodes relative to the target patterns, respectively, across the first and second ends included in the inspection region and arrange in lines, under the condition that each surface of the supply and sensor electrodes is spaced apart from each surface of the target patterns, supplying an AC inspection signal from the first end side of the inspection region of the target patterns, and detecting a signal from each of the target patterns to inspect the target patterns.

In the circuit pattern inspection method set forth in the second aspect of the present invention, each of the target patterns is a conductive pattern formed on a circuit board to have a bar-like shape with a given width.

This circuit pattern inspection method may include allowing the sensor electrode to have a width equal to or greater than a width of two lines of the target patterns, and detecting a signal from one of the adjacent target patterns a remaining one of which is supplied with the inspection signal, so as to allow the presence of short circuit between the adjacent target patterns to be determined.

The circuit pattern inspection method set forth in the second aspect of the present invention may include detecting a signal from one of the adjacent target patterns which is supplied with the inspection signal, through a first sensor electrode included in the sensor electrode so as to allow the presence of disconnection in the target pattern to be determined, and detecting a signal from a remaining one of the adjacent target patterns through a second sensor electrode included in the sensor electrode so as to allow the presence of short circuit between the adjacent target patterns to be determined.

The circuit pattern inspection method set forth in the second aspect of the present invention may include determining a general position of a disconnected region in the target pattern in accordance with a position of the sensor electrode where the detection means has no detection signal.

The circuit pattern inspection method set forth in the second aspect of the present invention may include evaluating whether a detection result of the detection means based on a detection signal from one of the target patters is in a given acceptable range, wherein when the detection result is in a given acceptable range, determining that the target pattern is normal, and, when the detection result is out of the given acceptable range, determining that the target pattern is defective.

This circuit pattern inspection method may include: specifying a position of the defective target pattern determined by the determination means and storing information about the position; moving the supply and sensor electrodes to respective positions opposed to the first and second ends of the defective target pattern in accordance with the stored information; moving either one of the supply and sensor electrodes along the defective target pattern toward the other electrode; and detecting a position where a detection signal from the defective target pattern has a change, in accordance with a detection result of the detection means, and defining the position as a defective position.

Further, the circuit pattern inspection method may include bringing either one of the supply and sensor electrodes into contact with the defective target pattern.

The circuit pattern inspection method may include providing image pickup means in either one of the supply and sensor electrodes, and moving the image pickup means together with the at least one electrode along the defective target pattern toward the other electrode.

The circuit pattern inspection method set forth in the second aspect of the present invention may include providing a displacement measurement device disposed at a position adjacent to the sensor or supply electrode and adapted to be moved together with the sensor or supply electrode, and positioning the sensor or supply electrode in a direction orthogonal to the inspection region in accordance with a detection result of the displacement measurement device, in such a manner as to allow a gap between the sensor or supply electrode and the inspection region to be maintained at an approximately constant value, so as to provide a stable detection result of the detection means.

This circuit pattern inspection method may include positioning the sensor or supply electrode on the basis of a gap between the sensor or supply electrode and the inspection region which is defined by an average displacement of a detection result of the displacement measurement device obtained from a plurality of pitches of the target patterns.

### BRIEF DESCRIPTION OF DRAWINGS

FIG. 1 is an explanatory diagram of an inspection principle in a circuit pattern inspection apparatus according to a first embodiment of the present invention.

FIG. 2 is a flowchart of an inspection control process in the circuit pattern inspection apparatus according to the first embodiment.

FIG. 3 is a waveform chart showing one example of a detection signal obtained by the circuit pattern inspection apparatus according to the first embodiment when three target patterns have a disconnected (open) region.

FIG. 4 is a waveform chart showing one example of a detection signal obtained by the circuit pattern inspection apparatus according to the first embodiment when one target pattern has a short-circuited (short) region.

FIG. 5 is a block diagram showing a circuit pattern inspection apparatus according to a second embodiment of the present invention.

FIG. 6 is a block diagram showing a circuit pattern inspection apparatus according to a third embodiment of the present invention.

FIG. 7 is an explanatory diagram of a process of moving electrodes, in the circuit pattern inspection apparatus according to the third embodiment.

FIG. 8 is a flowchart of a process of specifying a defective-region position, in the circuit pattern inspection apparatus according to the third embodiment.

FIG. 9 is a waveform chart showing one example of a detection signal obtained from a defective target pattern through a sensor electrode in the circuit pattern inspection apparatus according to the third embodiment.

FIG. 10 is a waveform chart showing one example of a detection signal obtained from the sensor electrode through a defective target pattern.

FIG. 11 is a block diagram showing a circuit pattern inspection apparatus according to a fourth embodiment of the present invention.

### BEST MODE FOR CARRYING OUT THE INVENTION

With reference to the drawings, the present invention will now be described in detail in connection with a specific embodiment thereof.

While the following description will be made on the assumption that a circuit pattern inspection apparatus according to the embodiment is designed to inspect the presence of defect in a dot-matrix pattern formed on a circuit board before being incorporated in a dot-matrix liquid-crystal display panel, the present invention is not limited to the following embodiment, but may be applied to inspection for any circuit board in which at least a plurality of target patterns have opposite end portions arranged in rows or lines.

### First Embodiment

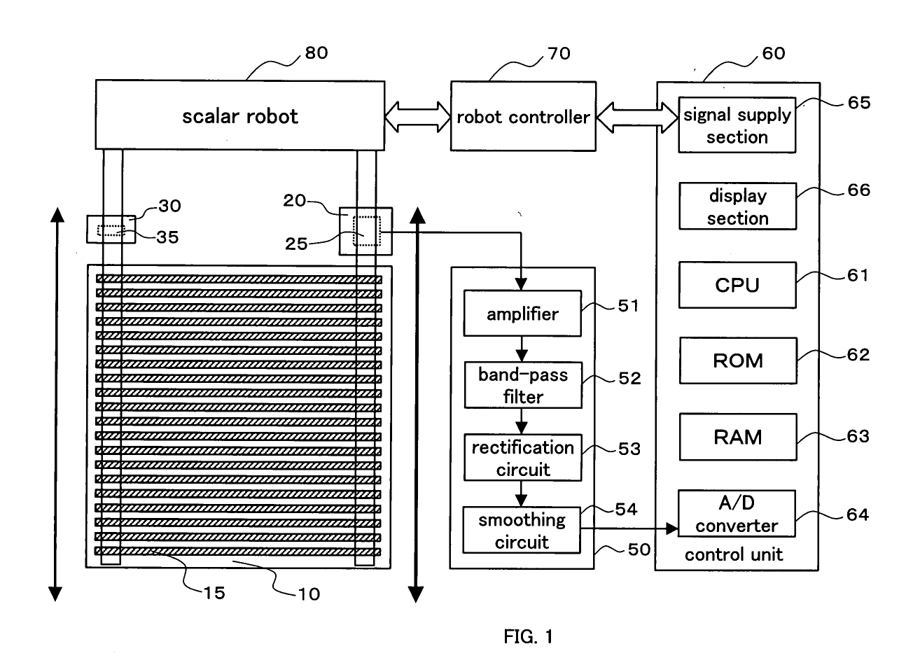

FIG. 1 is an explanatory diagram of an inspection principle in a circuit pattern inspection apparatus according to a first embodiment of the present invention.

In FIG. 1, the reference numeral 10 indicates a circuit board formed with a plurality of conductive patterns 15 to be inspected by the inspection apparatus according to the first embodiment. In this embodiment, the circuit board 10 is a glass circuit board for use in a dot-matrix liquid-crystal display panel. The conductive patterns 15 are arranged in lines at even intervals on a surface of the glass circuit board 10. Each of the conductive patterns 15 illustrated in FIG. 1 has approximately the same width. While the conductive patterns 15 are arranged at even intervals, the inspection apparatus according to the first embodiment can perform an adequate inspection even if the conductive patterns are arranged at uneven intervals.

The reference numeral 20 indicates a sensor section; 30 indicates an inspection signal supply section; 50 indicates an analog signal processor for processing a detection signal from the sensor section 20 and sending the processed signal to a control unit 60 for generally governing the control of the inspection apparatus; and 70 indicates a robot controller for controlling a scalar robot 80 which is operable to move and hold the circuit board 10 to/in an inspection zone, and then scanningly move a sensor electrode 25 of the sensor section 20 and a supply electrode 35 of the inspection signal supply section 30 in such a manner that they sequentially get across all connection terminals of the conductive patterns or target patterns, under the control of the robot controller 70.

In this embodiment, the scalar robot 80 has a three-dimensional positioning function for moving and holding the circuit board 10 to/in a given inspection zone, and moving the sensor section 20 and the inspection signal supply section 30 above the target patterns with a given distance relative to the surface of the circuit board 10.

While the above inspection apparatus is designed such that the scalar robot 80 is controlled to move the sensor section 20 and the inspection signal supply section 30 above the target patterns with a given distance relative to the surface of the circuit board 10, the present invention is not limited to such a control. Specifically, the sensor section 20 and the inspection signal supply section 30 may be fixed, and the scalar robot 80 may be controlled to move the circuit board 10 with a given distance relative to the respective electrodes 25, 35 of the sensor section 20 and the inspection signal supply section 30, so as to obtain the same effect.

In an actual inspection, if the target patterns are arranged at uneven intervals or their opposite ends or terminals are different in pattern pitch, the sensor electrode 25 and the supply electrode 35 have to be synchronizingly moved in such a manner that, when the supply electrode 35 is located above one end of a specific one of the target patterns to supply an inspection signal thereto, at least a portion of the sensor electrode 25 is located above the other end of the specific target pattern (one end of each target pattern on the side of the supply electrode 35 and the other end of the target pattern on the side of the sensor electrode 25 will hereinafter be referred to respectively as “first end (or first terminal)” and “second end (or second terminal)”). Thus, even if the target patterns are arranged at uneven intervals or their first and second opposite ends are different in pattern pitch, an adequate inspection can be performed by simply controlling the scalar robot to adjust respective movement speeds of the sensor and supply electrodes.

In this embodiment, the sensor electrode 25 is provided on at least a portion of a top surface of the sensor section 20, and the supply electrode 35 is provided on at least a portion of a top surface of the inspection signal supply section 30. Each of the sensor electrode 25 and the supply electrode 35 are made of metal, such as copper (Cu) or gold (Au). Each of the electrodes 25, 35 may be coated with a protective insulating material. While each of the electrodes 25, 35 may be made of a material other than metal, such as semiconducting material, the metal electrode makes it possible to obtain a larger electrostatic capacity relative to the conductive patterns.

The inspection signal supply section 30 is moved across the first terminals of the target patterns by the scalar robot 80, so as to sequentially supply the inspection signal to the target patterns through a capacitive coupling. Preferably, the outermost surface of the supply electrode 35 has a width equal to or less than one pitch of the target patterns (or a width equal to or less than the sum of the width of one target pattern and the interval or distance between the adjacent target patterns).

If the width of the supply electrode 35 is greater than the pitch of the target patterns, the sensor electrode 25 of the sensor section 20 is likely to detect the inspection signal from three or more of the target patterns.

However, it is not essential for the supply electrode 35 to have a width equal to or less than one pitch of the target patterns. Specifically, the inspection apparatus may be designed to have a sensor section capable of figuring out each state of two or more of the target patterns and the target patterns adjacent thereto, and perform an inspection according to an inspection process described in detail later.

The sensor section 20 is moved across the second terminals of the target patterns 10 by the scalar robot 80, so as to sequentially detect the inspection signal from the inspection signal supply section 30 through a capacitive coupling. Preferably, the outermost surface of the sensor electrode 25 has a width greater than the width of the supply electrode 35 by at least one pitch of the target patterns.

A detection signal from the sensor section 20 is sent to the analog signal processor 50, and subjected to an analog signal processing therein. The processed analog signal is sent from the analog signal processor 50 to the control unit 60 to determine the presence of defect in the target patterns 10 associated with the inspection signal supply section 30. The control unit 60 is also operable to controllably supply the inspection signal to the inspection signal supply section 30.

The analog signal processor 50 comprises an amplifier 51 for amplifying the detection signal from the sensor section 20, a band-pass filter 52 for eliminating noise components of the amplified detection signal from the amplifier 51 and outputting the filtered detection signal, a rectification circuit 53 for full-wave-rectifying the filtered detection signal from the band-pass filter 52, and a smoothing circuit 54 for smoothing the full-wave-rectified detection signal from the rectification circuit 53. In the analog signal processor 50, the rectification circuit 53 and the smoothing circuit 54 may be omitted.

The control unit 60 for generally governing the control of the inspection apparatus comprises a central processor (CPU) 61, a ROM 62 for storing a control program to be executed by the CPU 61 and others, a RAM 63 for temporarily storing information about progress of processing in the CPU 61, the detection signal and others, an A/D converter 64 for converting the analog signal from the analog signal processor 50 to a corresponding digital signal, a signal supply section 65 for supplying an inspection signal to the inspection signal supply section 30, and a display section 66 for displaying an inspection result, an operational instruction/guidance and others.

The signal supply section 65 generates an inspection signal having, for example, of an AC sine wave of 200 kHz and 200 V, and supplies the inspection signal to the inspection signal supply section 30. In this case, the band-pass filter 52 is set to allow the inspection signal having a given frequency, such as 200 kHz, to pass therethrough. It is to be understood that the inspection signal is not limited to the sine wave, but may be any other suitable AC signal having, for example, a rectangular or pulse wave.

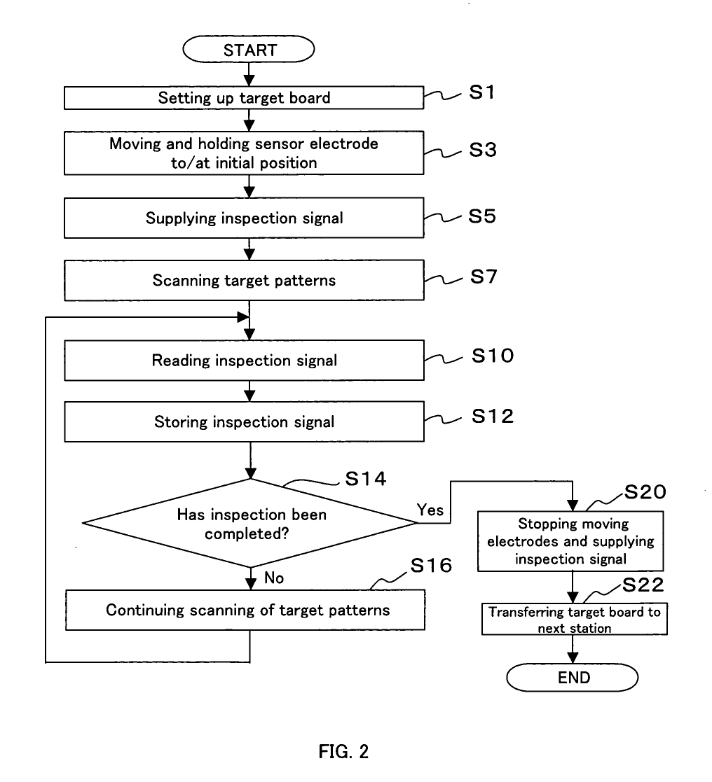

With reference to the flowchart illustrated in FIG. 2, a control process of inspecting the conductive patterns in the above circuit pattern inspection apparatus according to the first embodiment will be described below.

In the inspection process using the inspection apparatus according to the first embodiment, the glass circuit board 10 formed with the conductive patterns or target patterns is transferred along a transfer path (not shown) to a station for the circuit pattern inspection apparatus (work station). Then, in Step S1, the circuit board 10 (hereinafter referred to as “target board”) is set up in the inspection apparatus. The automatically transferred target board may be automatically set up in the inspection apparatus using a transfer robot (not shown) or may be manually set up in the inspection apparatus by an operator. Upon completion of the setting of the target board in the inspection apparatus, the control unit 60 activates the robot controller 70 to control the scalar robot 80 so as to move and hold the target board to/in an inspection zone.

Subsequently, in Step S3, the supply electrode 35 of the inspection signal supply section 30 is moved to an initial position on the side of the first ends of the target patterns 15 of the target board 10 (a position spaced apart upward from the first end of the endmost target pattern by a given distance), and the sensor electrode 25 of the sensor section 20 is moved to an initial position on the side of the second ends of the target patterns (a position spaced apart upward from the second end of the endmost target pattern by a given distance).

In this embodiment, the distance or gap between each of the target patterns and each of the electrodes 25, 35 is maintained in a given range, for example, of 100 to 200 μm. The gap is determined by the size of the target pattern, and thereby the value of the gap is not limited to the above range. Specifically, the gap may be set at a larger value as the size of the target pattern becomes larger, and should be set at a smaller value as the size of the target pattern becomes smaller.

If the target pattern has a significantly small size or the gap has to be reduced, each surface of the electrodes may be coated with an insulating material to prevent a direct contact between the target pattern and the electrode. In this case, the insulation material may be formed to have a thickness approximately equal to the gap or to allow the sensor section 20 and the inspection signal supply section 30 to be brought into direct contact with the target board through the insulating material. This makes it possible to maintain the distance between each of the target patterns and each of the electrodes at a constant value readily and accurately during inspection. Thus, even if the target board has significantly fine conductive patterns, an accurate inspection result can be readily obtained in a simplified structure.

Subsequently, in Step S5, the CPU 61 instructs the signal supply section 65 to start to supply the inspection signal to the supply electrode 35 of the inspection signal supply section.

Then, the process advances to Step S7 to start a control for synchronizingly moving the electrodes 25, 35 of the sensor section 20 and the inspection signal supply section 30 across the target patterns, and maintaining the distance between each of the target patterns and each of the electrodes 25, 35 at a constant value. Under this control, the sensor electrode 25 will sequentially detect a signal potential from each of the target patterns supplied with the inspection signal from the supply electrode 35 through the capacitive coupling therebetween.

Specifically, the sensor electrode 25 is controllably moved in such a manner that, when the supply electrode 35 is located at a position opposed to a specific one of the target patterns to supply the inspection signal thereto, at least a portion of the sensor electrode 25 is located opposed to the second end of the specific target pattern supplied with the inspection signal. Further, the sensor electrode 25 on the side of the second ends is controllably moved by one pitch of the target patterns as the supply electrode 35 on the side of the first ends is moved by one pitch of the target patterns.

Simultaneously, in Step S10, the signal processor 50 is activated to process the detection signal from the sensor electrode 25 and send the processed detection signal to the control unit 60. As described above, in the signal processor 50, the amplifier 51 amplifies the detection signal from the sensor electrode 25 up to a required level, and sends the amplified detection signal to the band-pass filter 52 to pass therethrough only frequency components corresponding to those of the detection signal so as to eliminate noise components. Then, the rectification circuit 53 full-wave-rectifies the filtered detection signal from the band-pass filter 52, and the smoothing circuit 54 smoothes the full-wave-rectified detection signal and sends the smoothed detection signal to the A/D converter 64.

The CPU 61 activates the A/D converter 64 to convert the input analog signal to a corresponding digital signal, and reads the detection signal detected by the sensor electrode 25 in the form of a digital value.

Then, in Step S12, the CPU 61 sends the read detection signal to the ROM 63. The ROM stores the read detection signal in a time-series manner. This read detection signal includes the detection signal from all of the target patterns including a normal target pattern, a target pattern having a disconnected region, and a target pattern short-circuited with an adjacent target pattern supplied with the inspection signal.

In Step S14, the CPU 61 determines whether all of the target patterns have been inspected, for example, whether the sensor electrode 25 has been moved to a position beyond the last target pattern (whether the inspection of all of the target patterns has been completed).

If the inspection of a part of the target patterns has not been completed, the process will advance to Step S16 to continue scanningly moving the electrodes and supply the inspection signal to the remaining target patterns. Then, the process will return to Step S10 to continue the read operation.

When the determination in Step S14 is YES or it is determined that all of the target patterns have been inspected, the process advances to Step S20. In Step S20, the CPU 61 instructs the signal supply section 65 to stop supplying the inspection signal, and instructs the signal processor 50 and the A/D converter 64 to stop their operations.

Lastly, in Step S22, the target board is taken out of the inspection zone. Then, the circuit board is positioned at a transfer position, and transferred to a next station to perform a required remaining operation.

According to the above inspection process, the circuit pattern inspection can be performed without any contact between each of the sensor and supply electrodes 25, 35 and each of the target patterns. This allows the circuit board having low-strength target patters to be inspected without occurrence of scratches in the target patters.

Thus, while a glass circuit board for a liquid-crystal display panel to be used in small portable phones has difficulties in ensuring a sufficient strength in wiring patterns, even such wiring patterns can be reliably inspected without damage thereof.

Further, in the inspection process using the inspection apparatus according to the first embodiment, the sensor electrode 25 and the supply electrode 35 are moved across the target patterns to allow the supply electrode 35 to supply an AC sine-wave signal or continuous signal to the target patterns and allow the sensor electrode 25 to detect a signal potential from the target patterns. Thus, the signal potential, or a detection signal obtained from the sensor electrode 25, normally has an approximately constant continuous value.

Thus, if the plurality of target patterns formed on the target board include a defective target pattern having an open region (disconnected target pattern) or a short region short-circuited with an adjacent target pattern (short-circuited target pattern), a certain difference will occur between an approximately constant continuous value detected at successive positions of normal target patterns without open and short, and a defective value detected at a position of a defective target pattern with open or short.

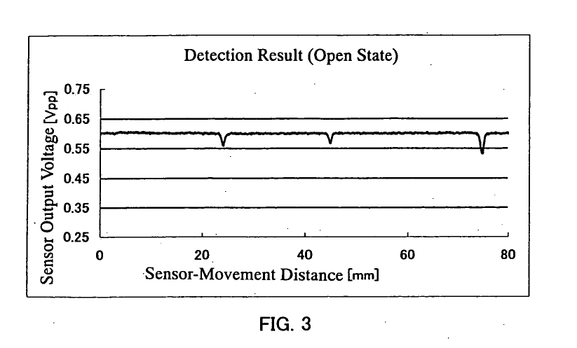

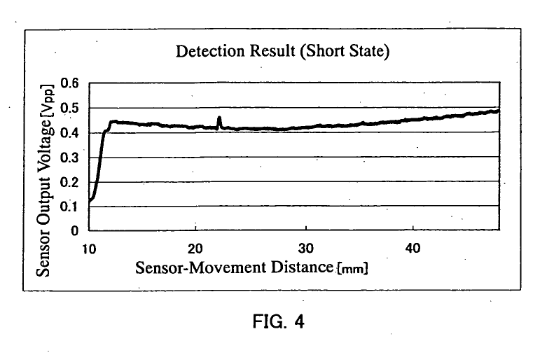

As above, a difference or change in value of the detection signal due to the defect, such as open or short, appears in the detection signal having the approximately constant continuous value. For example, the detection result can be graphed as shown in FIGS. 3 and 4 to facilitate determining the presence of defect in the target board and specifying a position of the defective target pattern with open or short. This will be described in more detail later.

When the inspection process using the inspection apparatus is performed by continuously replacing a target board with next one, the approximately constant continuous value of the detection signal varies in absolute value every time the target board is replaced, due to changes in the gap between the sensor or supply electrode 25, 35 and each target pattern, and other factor.

Even under this situation, the conductive pattern inspection process using the inspection apparatus according to the first embodiment makes it possible to determine the presence of defect in the target board and specify a position of the defective target pattern with open or short (hereinafter referred to as “defective-pattern position”), in accordance with a change in value appearing in the detection signal having the approximately constant continuous value due to the defect, such as open or short, or a relative change in detection-signal value.

As a threshold value for determining the presence of defect and specifying the defective-pattern position, an absolute value of a ratio between the continuous value and the defective value or a change rate of the defective value in the detection signal may be used. That is, without having to use the approximately constant continuous value as an absolute value, the inspection process using the inspection apparatus can be performed to reliable determine the presence of defect in the target patterns and specify the defective-pattern position even if a target board is continuously replaced with next one.

In the conductive pattern inspection process using the inspection apparatus according to the first embodiment, an additional step of determining whether the detection signal read in Step S12 falls within a threshold range defined by the above absolute value may be provided between Steps S12 and S14. In this step, if the detection result is in the threshold range, the process will advance to Step S14. When the detection result is not in the threshold range, the target pattern supplied with the inspection signal is considered as the defective target pattern with open or short, and information about the position and state of the defective target pattern is stored.

An example of a detection signal detected by the sensor electrode 25 according to the above inspection process is shown in FIGS. 3 and 4. Specifically, FIG. 3 shows a detection signal obtained when three target patterns have a disconnected (open) region, and FIG. 4 shows a detection signal obtained when one target pattern has a short-circuited (short) region.

When the target patterns are in the normal state, the inspection signal (AC signal) from the signal supply section 65 to the supply electrode 35 is sequentially supplied to each of the target patterns capacitively coupled with the supply electrode 35. Then, the inspection signal reaching below the sensor electrode 25 through each of the target patterns capacitively coupled with the sensor electrode 25 is detected by the sensor electrode 25 through the capacitive coupling relative to the target patterns and the detection signal is output to the control section 60.

In this way, the supply electrode 35 and the sensor electrode 25 are moved across the target patterns to supply and detect the inspection signal (AC signal). Thus, the detection signal has an approximately continuous constant value.

When at least one of the target patterns has a disconnected region, at least a part of the inspection signal (AC signal) from the signal supply section 65 to the supply electrode 35 does not reach the second ends of the target patterns on the side of the sensor electrode 25 due to the disconnected region of the target pattern, and thereby the detection signal has a reduced value. Thus, as shown in FIG. 3, the detection signal has a smaller value at a position of the disconnected target pattern as compared to the constant continuous value detected at the positions of the normal target patterns

When one of the target patterns has a region short-circuited with the adjacent target pattern, the inspection signal (AC signal) supplied from the supply electrode 35 to the short-circuited target pattern also flows to the adjacent target pattern through the short region, and thereby the detection signal of the sensor electrode 25 has an increased value, because the detection signal from the adjacent target pattern is superimposed on the detection signal from the short-circuited target pattern. Thus, as shown in FIG. 4, the detection signal has a larger value at a position of the short-circuited target pattern as compared to the constant continuous value detected at the positions of the normal target patterns.

As above, both disconnection and short in the target patterns can be detected only by the single sensor electrode 25. This can be achieved because the sensor electrode 25 is designed to have a width greater than that of the supply electrode 35 by at least one pitch of the target patterns.

However, it is not essential for the sensor electrode 25 to have a width greater than that of the supply electrode 35 by at least one pitch of the target patterns. Specifically, the inspection apparatus may be designed such that a disconnected target pattern and a target pattern short-circuited with an adjacent target pattern supplied with the inspection signal are individually inspected, for example, as in a second embodiment described in detail later.

In this case, a given threshold range may be set based on the absolute value of the approximately constant continuous value of the detection signal, so that the determination on the disconnected target pattern is made when the detection signal has a value less than a lower threshold value, and the determination on the short-circuited pattern is made when the detection signal has a value greater than an upper threshold value. For example, in FIG. 4, given that a threshold range is set at 0.02 Vpp based on the approximately constant continuous value or 0.66 Vpp, each of the target patterns located at respective sensor-movement distances of about 22, 42 and 78 mm is determined as the disconnected target pattern, because they have a value less than a lower threshold value of 0.58.

When an absolute value of a ratio between the continuous value and the defective value or a change rate of the defective value in the detection signal is used as a threshold value for determining the presence of defect in the target patterns and specifying the defective-pattern position, the determination on the disconnected target pattern may be made when the continuous value goes down at 3% or more, and the determination on the short-circuited pattern may be made when the continuous value goes up at 3% or more.

As above, in this embodiment, not only an absolute value but also a relative change of the value of the defective target pattern to the value of the normal target patterns in the detection signal can be used as a threshold value for determining the presence of defect in the target patterns. Thus, even if the inspection process using the inspection apparatus is performed by continuously replacing a target board with next one, an optimal threshold value can be set depending on a detection result. That is, even if the continuous value of the detection signal has variation in each inspection or becomes lower, adverse affects thereof can be fully prevented to obtain an accurate inspection result.

While the detection signal obtained through this inspection process has a minute value due to the sensor section and the inspection signal supply section each designed in the non-contact type, the inspection apparatus according to the first embodiment makes it possible to reliably distinguish a change in the minute value so as to inspect the state of each target patterns readily and reliably.

Thus, as compared to a conventional method using only the absolute value of the detection signal as a threshold value for determining the presence of defect in the target patterns, the presence of defect in the target patterns can be determined with significantly enhanced accuracy and simplicity. In addition, the inspection apparatus designed in the non-contact type can eliminate the need for accurate positioning to inspect a circuit board with a high degree of accuracy even if it has target patterns arranged in an extremely fine pitch.

### Second Embodiment

The inspection apparatus according the first embodiment is designed such that at least a portion of the sensor electrode 25 is essentially located opposed to the second end of a target pattern currently supplied with the inspection signal from the supply electrode 35. The present invention is not limited to the first embodiment. For example, a plurality of sensor electrodes 25 may be provided, wherein one of the sensor electrodes 25 is located opposed to the second end of a first target pattern currently supplied with the inspection signal from the supply electrode 35, and at least one of the remaining sensor electrodes 25 is located opposed to the second end of a second target pattern adjacent to the first target pattern.

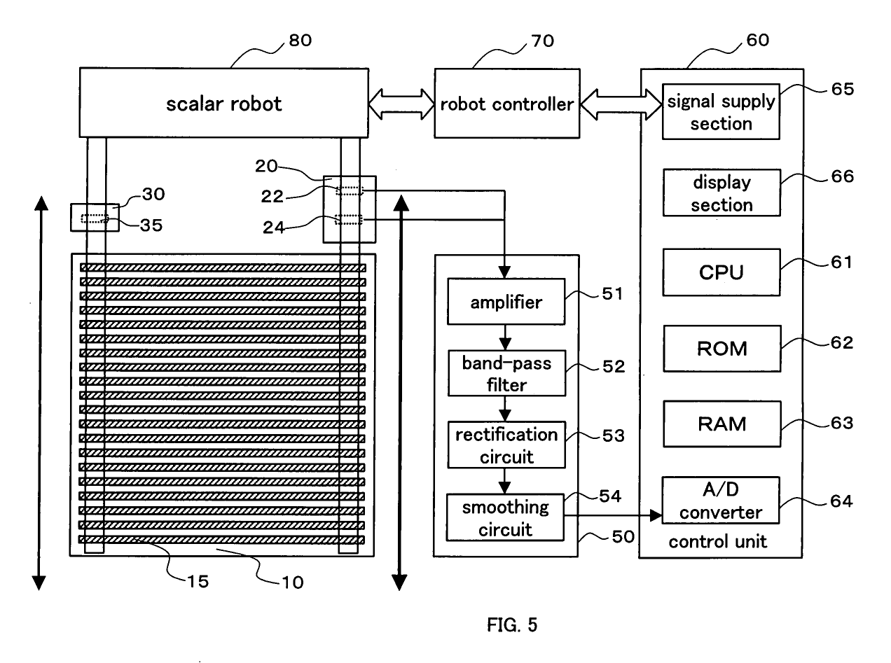

A circuit pattern inspection apparatus according to a second embodiment of the present invention is designed based on this technical concept. With reference to FIG. 5, the inspection apparatus according to the second embodiment will be described below.

In FIG. 5, the same element or component as that of the inspection apparatus according to the first embodiment illustrated in FIG. 1 is defined by the same reference numeral, and its detailed description will be omitted.

Referring to FIG. 5, a first sensor electrode 22 and a second electrode 24 are provided on at least a top surface of a sensor section 20. The first and second sensor electrodes 22, 24 are spaced apart from one another by one pitch of a plurality of target patterns 15. More specifically, the first second sensor electrodes 22, 24 are arranged on the sensor section 20 in such a manner that, when the sensor section 20 and a supply electrode 35 is synchronizingly moved, the first second sensor electrode 22 is located opposed to the second end of the target pattern currently supplied with an inspection signal from a supply electrode 35 (such a target pattern will hereinafter be referred to as “signal-receiving target pattern”), and the second sensor electrode 24 is located opposed to the second end of the target pattern adjacent to the signal-receiving target pattern (such a target pattern will hereinafter be referred to as “adjacent target pattern”).

Preferably, each of the first second sensor electrodes 22, 24 has a width equal to or less than each width of the target patterns. This setting is intended to assign to the first sensor electrode 22 a role of inspecting the presence of disconnection in the signal-receiving target pattern and to the second electrode 24 a role of inspecting the presence of short-circuit between the signal-receiving target pattern and the adjacent target pattern, so as to achieve a highly accurate inspection.

Specifically, even if the signal-receiving target pattern is short-circuited with the adjacent target pattern, the first sensor electrode 22 having a width equal to or less than each width of the target patterns can suppress an affect of a detection signal from the adjacent target pattern, which is caused by the inspection signal flowing in the adjacent target pattern from the signal-receiving target pattern through a short-circuited region. Further, when the target patterns have neither disconnection nor short, and even if the signal-receiving target pattern has no disconnection but a short-circuit with the adjacent target pattern, the second sensor electrode 24 having a width equal to or less than each width of the target patterns can suppress an affect of a detection signal from the signal-receiving target pattern.

Thus, the inspection of disconnection and short-circuit using the first and second sensor electrodes 22, 24 can be performed with a significantly high degree of accuracy, regardless of whether the signal-receiving target pattern has a disconnection and whether the signal-receiving target pattern has a short-circuit with the adjacent target pattern.

However, as seen in the sensor electrode 25 in the first embodiment, it is not essential for the first and second sensor electrodes 22, 24 to have a width equal to or less than each width of the target patterns.

While the inspection apparatus according to the second embodiment has only the second sensor electrode 24 as a sensor electrode to be located opposed to the adjacent target pattern, a third sensor electrode may be additionally provided to obtain a detection signal from another adjacent target pattern on the opposite side of the above adjacent target pattern relative to the signal-receiving target pattern. The addition of the third sensor electrode makes it possible to simultaneously detect whether the signal-receiving target pattern is short-circuited with either one or both of the two adjacent target patterns.

Further, it is to be understood that the sensor section 20 may be provided with only the first electrode 22 or only the second sensor electrode 24, or may be provided with three or more of the sensor electrodes to be located opposed, respectively, to three or more adjacent target patterns.

### Third Embodiment

While the aforementioned inspection apparatuses according to the first and second embodiments are designed to move the sensor electrode 25 and the supply electrode 35 across the ends of the target patterns so as to detect a defective target pattern, the present invention is not limited to such embodiments. For example, either one of the sensor electrode 25 and the supply electrode 35 may be designed to be controllably moved along each of the target patterns, wherein, when a defective target pattern is detected and discriminated by the aforementioned process, the supply and sensor electrodes are positioned at the first and second ends of the defective target pattern, and one of the electrodes is moved along the defective target pattern to read a value of a detection signal from the sensor electrode 25 so as to detect a position where the value of the detection signal is changed, and specify the position as a defective-region position in the defective target pattern.

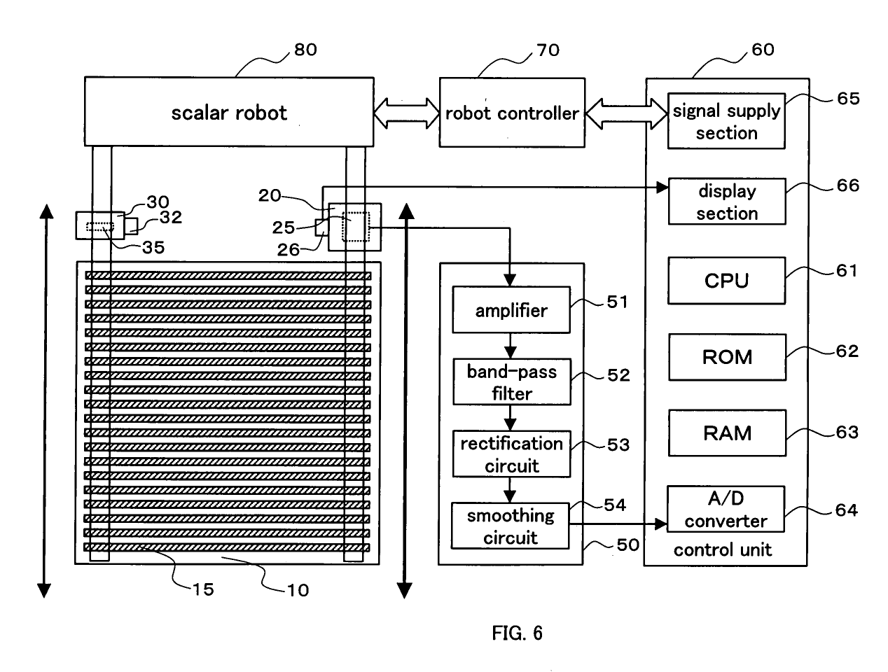

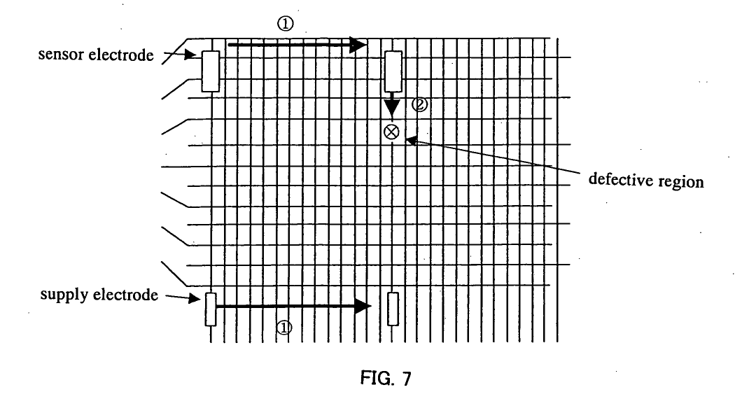

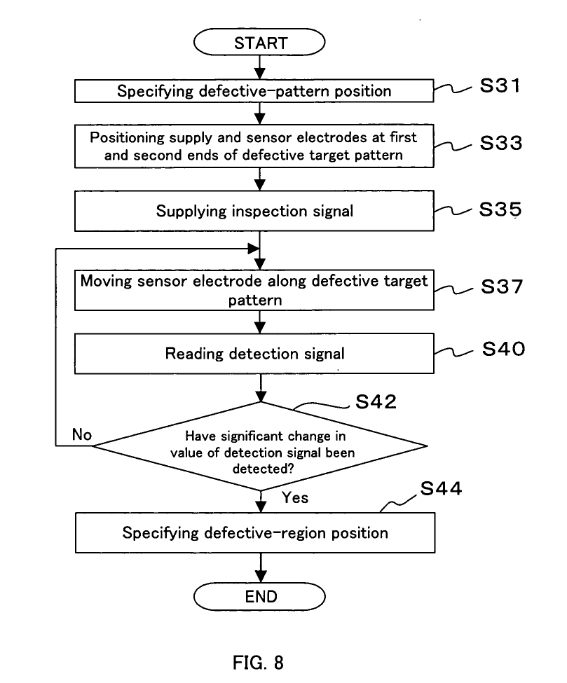

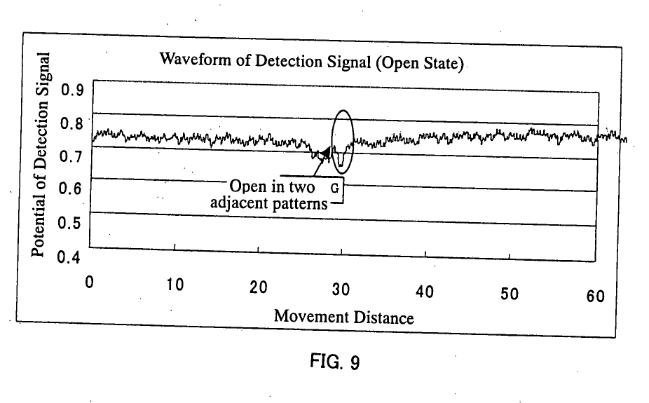

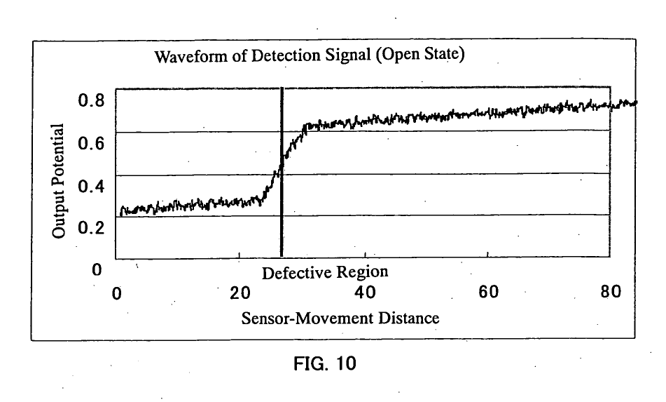

A circuit pattern inspection apparatus according to a third embodiment of the present invention is designed based on this technical concept. The inspection apparatus according to the third embodiment will be described below with reference to FIGS. 6 to 10, wherein: FIG. 6 is a block diagram showing the inspection apparatus; FIG. 7 is an explanatory diagram of a process of moving electrodes, in the inspection apparatus; FIG. 8 is a flowchart of a process of specifying a defective-pattern position, in the inspection apparatus; FIG. 9 is a waveform chart showing one example of a detection signal obtained from a defective target pattern through a sensor electrode 25 in the inspection apparatus; and FIG. 10 is a waveform chart showing one example of a detection signal obtained from a defective target pattern through the sensor electrode 25.

In FIG. 6, the same element or component as that of the inspection apparatus according to the first embodiment illustrated in FIG. 1 is defined by the same reference numeral, and its detailed description will be omitted.

Referring to FIG. 6, a camera 26 is attached to a sensor section 20. This camera 26 is disposed to take or pick up an image of target patterns 15, and connected, for example, to a display section 66 of a control section to display the image so as to observe the state of a defective target pattern. Further, a probe-contacting device 32 is provided in an inspection signal supply section 30, and an inspection signal supply probe for supplying an inspection signal to a defective target pattern is attached to the probe-contacting device 32. The probe-contacting device 32 and the inspection signal supply probe are used for reliably specifying the defective-region position.

In the third embodiment, a scalar robot 80 is designed to controllably move at least one of the supply and sensor electrodes along not only directions indicated by the arrows in FIG. 6 but also a longitudinal direction of the target patterns 15.

As with the inspection apparatus according to the first embodiment, it is firstly inspected whether a defect exists in the target patterns, through the process described in the flowchart of FIG. 2. As the result of the inspection, if a defective target pattern, such as a disconnected target pattern, is detected, a position of the defective target pattern or a defective-pattern position will be stored, for example, in a ROM 63.

After detecting the defective target pattern and specifying the defective-pattern position in the above way, a process of specifying a defective-region position is performed. In the process of specifying a defective-region position using the inspection apparatus according to the third embodiment, a supply electrode 35 and the sensor electrode 25 are synchronizingly moved in a direction indicated by the arrows (1) in FIG. 7 to the defective-pattern position.

Then, the sensor electrode 25 is moved from the second end toward the first end of the defective target pattern, as indicated by the arrow (2) in FIG. 7, to continuously obtain a detection signal so as to detect a position where the read signal is sharply changed (a position where the detection signal is changed to a zero or lower level) and specify the detected position as a defective-region position.

With reference to the flowchart in FIG. 8, the process of specifying a defective-region position will be described in more detail below. In advance of the process using the inspection apparatus according to the third embodiment, after Step S14 in the aforementioned first embodiment, the detection signal stored in the RAM 63 is checked to determine whether a defective target pattern has been detected. If it is determined that no defective target patter is detected, the process will advance to Step S20.

When it is determined that a defective target position has been detected as the result of the inspection, each of the supply and sensor electrodes is moved to the initial position as in Step S3 in FIG. 2, and the process is shifted to the routine as shown in FIG. 8. After completion of the routine in FIG. 8, the process may be shifted to Step S20.

As shown in FIG. 8, in the inspection process using the inspection apparatus according to the third embodiment, a defective-pattern position is firstly specified in Step S31, based on the detection signal obtained through Steps S1 to S16 in FIG. 2. For example, the waveform of a detection signal obtained when a part of the target patterns have a disconnected region is shown in FIG. 9. The example illustrated in FIG. 9 shows a signal waveform before the signal processing in the analog signal processor 50. The encircled portion of the signal waveform corresponds to a position of the target pattern having an open region (in this example, two of the target patterns has a disconnected region).

Then, in Step S33, the robot controller 70 is activated to control the scalar robot 80 in such a manner that the sensor electrode 25 and the supply electrode 35 are synchronizingly moved to the defective-pattern position. In order to detect a defective region with high sensitivity, each of the sensor and supply electrodes 25, 35 is moved to a position where a width-directional center thereof approximately corresponds to a width-directional center of the defective target pattern (see the arrows (1) in FIG. 7).

Subsequently, the process advances to Step S35. In Step S35, a signal supply section 65 is activated to apply an inspection signal to the supply electrode 35 so as to supply the inspection signal to the defective target pattern. Then, under the control of the robot controller 70, the sensor 25 is moved along the defective target pattern toward the supply electrode 35 (see the arrow (2) in FIG. 7).

Concurrently, in Step S40, a detection signal from the sensor electrode 25 is read. Then, in Step S42, it is determined whether a significant change in value of the detection signal from the sensor electrode 25 has been detected. If it is determined that no significant change has not been detected, the process will return to Step S37 to continue the movement of the sensor electrode 25.

When the determination in Step S42 is YES or it is determined that a significant change in value of the detection signal from the sensor electrode 25 has been detected, the process advances to Step S44. In Step S44, a first position where the significant change initially appeared in the detection signal and a second position where the significant change disappeared are determined, and an intermediate position between the first and second positions are specified as a defective-region position.

One example of the waveform of such a detection signal from the sensor electrode 25 is shown in FIG. 10. As shown in FIG. 10, before the sensor electrode 25 is moved beyond a disconnected region, the inspection signal supplied from the supply electrode 35 does not reach the sensor electrode 25, and thereby the detection signal has a low value. Then, when the sensor electrode 25 is moved beyond the disconnected region, the inspection signal reaches the sensor electrode 25 to increase the value of the detection signal. Given that an intermediate position between a first position where the significant change initially appeared in the detection signal from the sensor electrode 25 and a second position where the significant change disappeared is specified as a defective-region position, as in this embodiment, approximately an intermediate position of the inclined waveform in FIG. 10 is specified as a defective-region position.

The above inspection apparatus is designed to move the sensor electrode 25 toward the supply electrode 35. Alternatively, instead of the sensor electrode 25, the supply electrode 35 may be moved toward the sensor electrode 25.

As above, the inspection apparatus according to the third embodiment makes it possible to inspect the presence of defect in the target patterns with a high degree of accuracy as with the first embodiment. Further, the inspection apparatus according to the third embodiment is designed to move the sensor electrode in X-Y two directions. Thus, in addition to the inspection of the presence of a defective target pattern, a defective-region position can be specified. This allows the defective region to be promptly repaired according to need.

In the repair of the defective region, it is desirable to allow the state of the defective region to be visually observed so as to determine whether the defective region is repairable. For example, if it is observed that the defective region is simply caused by a dust attached thereto, it will be determined that the defective region is repairable. In contrast, if it is observed that the defective region has a fatal flaw, it can be determined that no repair is performed. The aforementioned camera 26 attached to the sensor section 20 is used in the observation of the state of the defective region. The camera 26 attached to the sensor section 20 starts picking up an image in Step S35. Then, the camera continuously picks up an image during Steps S40 to S44 or until the defective-region position is specified in Step S44. The mage of the defective region picked up in this way may be displayed on the display section 66 during the image pickup and even after the defective-region position is specified, to observe the state of the defective region in the defective target pattern.

The defective region includes various states, such as a complete open or short state, a partial open state, and a partial short state due to attached foreign substance, such as dust. In the inspection using the sensor electrode 25 and the supply electrode 35 each designed in a non-contact type, if a defective target pattern is in the partial open or short state, it can be difficult to obtain the waveform of the detection signal as in FIG. 10. In this case, the aforementioned probe-contacting device 32 is activated to bring the inspection signal supply probe into contact with the first end, and then the sensor electrode 25 is moved along the defective target pattern. This makes it possible to reliably specify a defective-region position.

Alternatively, in place of the sensor electrode 25 located opposed to the second end of the defective target pattern, a contact-type sensor probe may be used. In this case, the sensor probe is brought in contact with the second end of the defective target pattern, and the non-contact type supply electrode 35 is moved toward the sensor probe located on the first end of the defective target pattern.

### Fourth Embodiment

The inspection apparatus according to the third embodiment is designed to move the sensor electrode 25 and the supply electrode 35 2-dimensionally or in the X-Y directions. This control is performed because the target board is a circuit board for a liquid-crystal panel, and a glass circuit board having a high degree of flatness. In an inspection of a circuit board formed with a conductive pattern having a large thickness, or a large circuit board inevitably having irregularities in a surface thereof, the inspection apparatus may be designed to move the sensor electrode 25 and the supply electrode 35 not only 2-dimensionally but also in a vertical (Z) direction, so as to obtain an adequate inspection result regardless of the presence of irregularities in the surface of the target board.

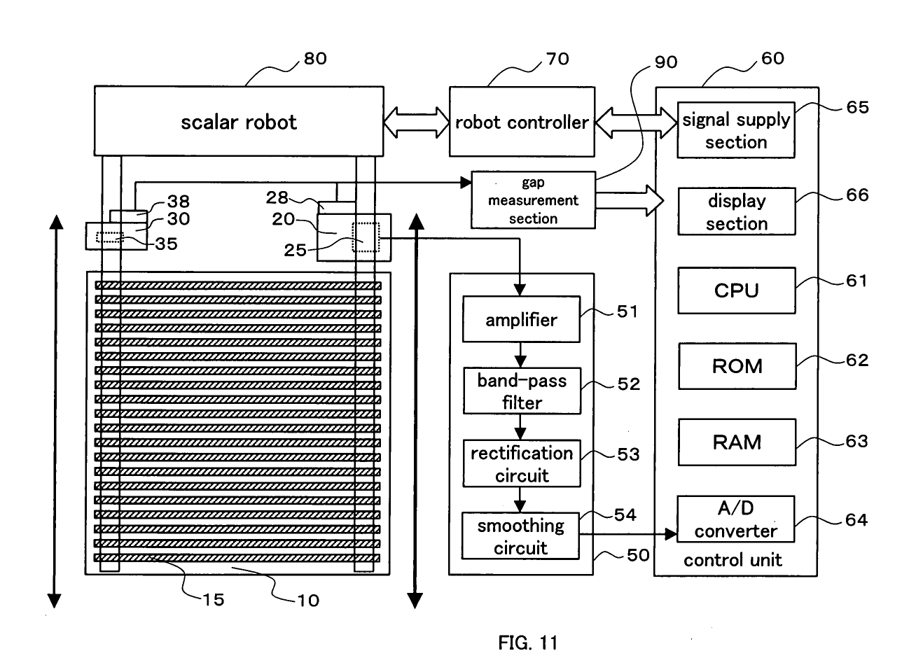

Based on this technical concept, a circuit pattern inspection apparatus according to a fourth embodiment of the present invention is designed to move a sensor section and an inspection signal supply section not only 2-dimensionally but also in a vertical (Z) direction. The inspection apparatus according to the fourth embodiment will be described below with reference to FIG. 11. In FIG. 11, the same element or component as that of the inspection apparatus according to the first embodiment illustrated in FIG. 1 is defined by the same reference numeral, and its detailed description will be omitted.

Referring to FIG. 11, the inspection apparatuses includes first and second laser displacement measurement devices 28, 38 attached, respectively, to a sensor section 20 and an inspection signal supply section 30, and a gap measurement section 90 for measuring a gap between each of the sensor section 20 and the inspection signal supply section 30 and a surface of a target board 10 or each of a plurality of target patterns formed thereon, in accordance with a detection result from each of the first and second displacement measurement devices 28, 38.

Further, the scalar robot 80 is designed to move each of the sensor section 20 and the inspection signal supply section 30 2-dimensionally and in a direction perpendicular to the drawing sheet (a vertical direction).

In the above inspection apparatus according to fourth embodiment, in conjunction with the movement of a sensor electrode 25 and a supply electrode 35, the gap measurement section 90 activates the first and second laser displacement measurement devices 28, 38 to measure a gap between each of the electrodes and the surface of the target board, and outputs the measurement result to a control section 60. The control section 60 is operable to average the measurement result obtained by the gap measurement section 90 in a period where each of the electrodes is moved by a given distance, and control the gap between each of the electrodes and each of the target patterns in such a manner that the averaged gap is maintained at a constant value.

For example, the gap between each of the electrodes and the surface of the target board is controlled in accordance with an averaged gap of the measurement result obtained in a period where each of the electrodes is moved by a distance between the three adjacent target patterns The averaging of the measured gaps is performed for moving the electrodes at a moderate speed in the Z-direction without an excessively rapid control, and reducing an adverse affect, such as noises or measurement error.

The 3-dimensional or X, Y, Z-control is effective, particularly, in an inspection of large circuit boards. For example, while a circuit board for a large flat display panel has difficulties in avoiding a curvature of a surface thereof, the 3-dimensional control can effectively prevent the contact between each of the electrodes and target patterns on the surface of the circuit board during inspection.

Further, if the target patterns have a large thickness, the distance for measuring gaps to be averages may be reduced to provide enhanced detection sensitivity.

### INDUSTRIAL APPLICABILITY

As mentioned above, according to the present invention, the presence of defect in target patterns can be reliably detected.

Further, the state of a defective target pattern can be readily recognized, and the position of a defective region can be specified.

Furthermore, even if a target board has a surface with irregularities or curvature, it can be reliably inspected without damages of target patterns thereon.

1. A circuit pattern inspection apparatus for inspecting a plurality of target patterns having first and second opposite ends included in an inspection region thereof and arrange in lines, which is adapted to supply an AC inspection signal from the first end side of said inspection region of said target patterns, and detect a signal from the second end side of said inspection region, said circuit pattern inspection apparatus comprising:
supply means including a supply electrode for supplying said inspection signal from the first end side of said inspection region of said target patterns;
detection means including a sensor electrode for detecting a signal from each of said target patterns; and
moving means for moving said supply and sensor electrodes, respectively, across said first and second ends included in said inspection region and arrange in lines, with a given gap relative to each of said target patterns.

2. The circuit pattern inspection apparatus as defined in claim 1, wherein each of said target patterns is a conductive pattern formed on a circuit board, said conductive pattern having a bar-like shape with a given width.

3. The circuit pattern inspection apparatus as defined in claim 1 or 2, wherein said sensor electrode has a width equal to or greater than a width of two lines of said target patterns.

4. The circuit pattern inspection apparatus as defined in claim 1 or 2, wherein said sensor electrode includes:
a first sensor electrode adapted to be disposed at a position opposed to the second end of one of the adjacent target patterns which has the first end supplied with the inspection signal from said supply electrode; and
a second sensor electrode adapted to be disposed at a position opposed to the second end of a remaining one of said adjacent target patterns.

5. The circuit pattern inspection apparatus as defined in claim 4, wherein said first sensor electrode has a width equal to or less than each width of said target patterns.

6. The circuit pattern inspection apparatus as defined in claim 4, wherein said second sensor electrode has a width equal to or less than each width of said target patterns.

7. The circuit pattern inspection apparatus as defined in claim 1 or 2, wherein said moving means is adapted to move said supply and sensor electrodes, respectively, across said first and second ends included in said inspection region and arrange in lines, under the condition that each surface of said supply and sensor electrodes is capacitively coupled with each of said target patterns.

8. The circuit pattern inspection apparatus as defined in claim 1 or 2, which further includes determination means operable, when a detection result of said detection means based on a detection signal from one of said target patters is in a given acceptable range, to determine that said target pattern is normal, and, when a detection result of said detection means based on a detection signal from one of said target patters is out of said given acceptable range, to determine that said target pattern is defective.

9. The circuit pattern inspection apparatus as defined in claim 8, which includes:
second moving means for moving said supply and sensor electrodes to respective positions opposed to the first and second ends of said defective target pattern determined by said determination means, and moving either one of said supply and sensor electrodes along said defective target pattern toward the other electrode; and
position detection means for detecting a position where a detection signal from said defective target pattern has a change, in accordance with a detection result of said detection means.

10. The circuit pattern inspection apparatus as defined in claim 9, which includes contacting means for bringing either one of said supply and sensor electrodes into contact with said defective target pattern.

11. The circuit pattern inspection apparatus as defined in claim 9, wherein at least one of said supply and sensor electrodes which is to be moved by said second moving means includes an image pickup means.

12. The circuit pattern inspection apparatus as defined in claim 9, which includes a gap control means for positioning at least one of said supply and sensor electrodes which is to be moved by said second movement means, in such a manner as to allow a gap between said at least one electrode and said defective target pattern to be maintained at an approximately constant value.

13. The circuit pattern inspection apparatus as defined in claim 1 or 2, which includes a gap control means for positioning at least one of said supply and sensor electrodes to be moved by said movement means, in such a manner as to allow a gap between said at least one electrode and each of said target patterns to be maintained at a constant value.

14. The circuit pattern inspection apparatus as defined in claim 12, wherein said gap control means includes a displacement measurement device disposed at a position adjacent to said sensor or supply electrode and adapted to be moved together with said sensor or supply electrode, said gap control means being operable to position said sensor or supply electrode in a direction orthogonal to said inspection region in accordance with a detection result of said displacement measurement device, in such a manner as to allow a gap between said sensor or supply electrode and said inspection region to be maintained at an approximately constant value

15. The circuit pattern inspection apparatus as defined in claim 14, wherein said gap control means is operable to position said sensor or supply electrode in a direction orthogonal to said inspection region, on the basis of a gap between said sensor or supply electrode and said inspection region which is defined by an average displacement of a detection result of said displacement measurement device obtained from a plurality of pitches of said target patterns.

16. A circuit pattern inspection method for use in a circuit pattern inspection apparatus which comprises supply means including a supply electrode for supplying an inspection signal to each of a plurality of target patterns having first and second opposite ends included in an inspection region thereof and arrange in lines, from the first end side of said inspection region, and detection means including a sensor electrode for detecting a signal from each of said target patterns, said circuit pattern inspection method comprising:
moving said supply and sensor electrodes relative to said target patterns, respectively, across said first and second ends included in said inspection region and arrange in lines, under the condition that each surface of said supply and sensor electrodes is spaced apart from each surface of said target patterns;
supplying an AC inspection signal from the first end side of said inspection region of said target patterns; and
detecting a signal from each of said target patterns to inspect said target patterns.

17. The circuit pattern inspection method as defined in claim 16, wherein each of said target patterns is a conductive pattern formed on a circuit board, said conductive pattern having a bar-like shape with a given width.

18. The circuit pattern inspection method as defined in claim 17, which includes:
allowing said sensor electrode to have a width equal to or greater than a width of two lines of said target patterns; and
detecting a signal from one of the adjacent target patterns a remaining one of which is supplied with the inspection signal, so as to allow the presence of short circuit between said adjacent target patterns to be determined.

19. The circuit pattern inspection method as defined in claim 16 or 17, which includes:
detecting a signal from one of the adjacent target patterns which is supplied with the inspection signal, through a first sensor electrode included in said sensor electrode so as to allow the presence of disconnection in said target pattern to be determined; and
detecting a signal from a remaining one of said adjacent target patterns through a second sensor electrode included in said sensor electrode so as to allow the presence of short circuit between said adjacent target patterns to be determined.

20. The circuit pattern inspection method as defined in either one of claims 16 to 18, which includes determining a general position of a disconnected region in the target pattern in accordance with a position of said sensor electrode where said detection means has no detection signal.

21. The circuit pattern inspection method as defined in either one of claims 16 to 18, which includes evaluating whether a detection result of said detection means based on a detection signal from one of said target patters is in a given acceptable range, wherein when said detection result is in a given acceptable range, determining that said target pattern is normal, and, when said detection result is out of said given acceptable range, determining that said target pattern is defective.

22. The circuit pattern inspection method as defined in claim 21, which includes:
specifying a position of said defective target pattern determined by said determination means, and storing information about said position;
moving said supply and sensor electrodes to respective positions opposed to the first and second ends of said defective target pattern in accordance with said stored information;
moving either one of said supply and sensor electrodes along said defective target pattern toward the other electrode; and
detecting a position where a detection signal from said defective target pattern has a change, in accordance with a detection result of said detection means, and defining said position as a defective position.

23. The circuit pattern inspection method as defined in claim 22, which includes bringing either one of said supply and sensor electrodes into contact with said defective target pattern.

24. The circuit pattern inspection method as defined in claim 22, which includes:
providing image pickup means in either one of said supply and sensor electrodes; and
moving said image pickup means together with said at least one electrode along said defective target pattern toward the other electrode.

25. The circuit pattern inspection method as defined in either one of claims 16 to 18, which includes;
providing a displacement measurement device disposed at a position adjacent to said sensor or supply electrode and adapted to be moved together with said sensor or supply electrode; and
positioning said sensor or supply electrode in a direction orthogonal to said inspection region in accordance with a detection result of said displacement measurement device, in such a manner as to allow a gap between said sensor or supply electrode and said inspection region to be maintained at an approximately constant value, so as to provide a stable detection result of said detection means.

26. The circuit pattern inspection method as defined in claim 25, which includes positioning said sensor or supply electrode on the basis of a gap between said sensor or supply electrode and said inspection region which is defined by an average displacement of a detection result of said displacement measurement device obtained from a plurality of pitches of said target patterns.
